(19) United States
(12) Patent Application Publication
(10) Pub. No.: US 2024/0332989 A1
(43) Pub. Date: Oct. 3, 2024

(54) CHARGE CONTROL SYSTEM

(71) Applicant: HONDA MOTOR CO., LTD., Tokyo (JP)

(72) Inventors: Toshiyuki ABE, Tokyo (JP); Makoto URABE, Tokyo (JP); Yuki HAYASHI, Tokyo (JP)

(21) Appl. No.: 18/587,959

(22) Filed: Feb. 27, 2024

(30) Foreign Application Priority Data
Mar. 31, 2023 (JP) 2023-057138

(51) Int. Cl. H02J 7/00; B60L 53/16; B60L 53/30; B60L 53/65; B60L 53/80; H01M 10/42; H01M 10/46; H01M 50/204

(52) U.S. Cl. CPC H02J 7/0013; B60L 53/16; B60L 53/305; B60L 53/65; B60L 53/80; H01M 10/425; H01M 10/46; H01M 50/204; H02J 7/00032; H01M 2010/4278

(57) ABSTRACT

Provided is a charge control system capable of reducing costs for reuse of a battery module. The charge control system includes a charger, a plurality of IPUs, and a CAN bus, and each IPU includes a battery, a contactor, and a battery ECU. Based on operation information provided via the CAN bus, the battery ECU causes the contactor of one IPU from among the plurality of IPUs to provide power supply to the battery belonging to the one IPU and causes the contactor of a rest of the IPUs to disconnect power supply to the battery belonging to the rest of the IPUs, thereby performing control such that the charger charges the battery belonging to the one IPU without concurrently charging the battery belonging to the rest of the IPUs.

This application is based on and claims the benefit of priority from Japanese Patent Application No. 2023-057138, filed on 31 Mar. 2023, the content of which is incorporated herein by reference.

### BACKGROUND OF THE INVENTION

### Field of the Invention

The present invention relates to a charge control system.

### Related Art

In recent years, research and development has been carried out in relation to charge and power supply for mobility vehicles in which a secondary battery contributing to energy efficiency is mounted, in order to ensure many people have access to affordable, reliable, sustainable, and advanced energy.

Battery modules used in vehicles can be reused for other applications such as household use. For example, Japanese Unexamined Patent Application, Publication No. 2022-175595 proposes a technique for reusing a battery module.
Patent Document 1: Japanese Unexamined Patent Application, Publication No. 2022-175595

### SUMMARY OF THE INVENTION

Incidentally, in the techniques relating to the mobility vehicles having a secondary battery mounted therein, it is necessary to temporarily store the battery module before reuse. During the storage, the batteries constituting the battery module need to be periodically charged in order to suppress deterioration of the batteries.

In a case of storing a plurality of such battery modules, a plurality of chargers are required to charge all the battery modules, which leads to an increase in the cost for reuse of the battery modules.

It is an object of the present invention to achieve a charge control system capable of reducing costs for reuse of a battery module. The present invention in turn contributes to energy efficiency.

An aspect of the present invention is directed to a charge control system including: a charger; a plurality of battery modules that are electrically connected to the charger; and a communication line that allows for mutual communication between the plurality of battery modules. Each of the plurality of battery modules includes a battery, a disconnector configured to disconnect power supply from the charger to the battery, and a battery controller configured to control the battery modules. The communication line allows for transmission and reception of operation information regarding the disconnector between the battery modules. Based on the operation information provided via the communication line, the battery controller causes the disconnector of one battery module from among the plurality of battery modules to provide power supply to the battery belonging to the one battery module and causes the disconnector of a rest of the plurality of battery modules to disconnect power supply to the battery belonging to the rest of the plurality of battery modules, thereby performing control such that the charger charges the battery belonging to the one battery module without concurrently charging the battery belonging to the rest of the plurality battery modules.

The battery modules may have an identical identifier for mutual communication between the battery modules via the communication line.

The present invention provides the charge control system capable of reducing costs for reuse of battery modules.

### BRIEF DESCRIPTION OF THE DRAWINGS

FIG. 1 is a block diagram illustrating a configuration of a charge control system according to an embodiment;

FIG. 2 is a block diagram illustrating a configuration of an IPU according to the present embodiment;

FIG. 3 is a diagram illustrating contents of CAN data that is transmitted via a CAN bus; and

FIG. 4 illustrates, in time series, an example of charging operations by two IPUs according to the embodiment.

### DETAILED DESCRIPTION OF THE INVENTION

An embodiment of a charge control system according to the present invention will be described with reference to the accompanying drawings. It should be noted that the elements/components illustrated in the drawings, with reference to which the embodiment will be described, may not be true to scale. In addition, for the sake of description, some configuration may be omitted from the drawings, with reference to which the embodiment will be described. In the drawings and the specification, the same or similar elements/components are denoted by the same reference signs.

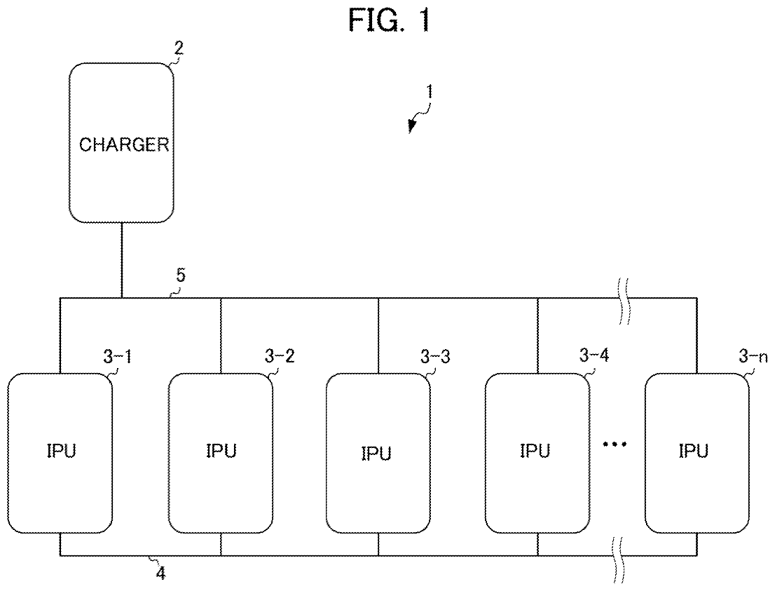

FIG. 1 is a block diagram illustrating a configuration of a charge control system 1 according to the present embodiment. The charge control system 1 is for use for temporarily storing intelligent power units (IPUs) 3-1 to 3-n that were mounted in vehicles, before the IPUs 3-1 to 3-n are reused. The charge control system 1 periodically charges the batteries included in the plurality of IPUs 3-1 to 3-n in order to suppress deterioration of the batteries.

Here, if the plurality of IPUs 3-1 to 3-n are concurrently charged, an excessive load will be applied to a charger 2 or an external power supply device. In addition, in a case where the plurality of IPUs 3-1 to 3-n have different rated voltages, the IPUs 3-1 to 3-n cannot be charged concurrently. To use different chargers, it is necessary to provide a plurality of charge control systems, which increases the cost for charge. For these reasons, the charge control system 1 according to the present embodiment performs control to charge the IPUs 3-1 to 3-n one by one.

As illustrated in FIG. 1, the charge control system 1 includes the charger 2, the plurality of IPUs 3-1 to 3-n as battery modules, a controller area network bus (CAN bus) 4, and a cable 5.

The charger 2 is constituted by, for example, an external power supply device, is electrically connected to the IPUs 3-1 to 3-n, and supplies power to the IPUs 3-1 to 3-n. Specifically, the charger 2 is connected in parallel to the plurality of IPUs 3-1 to 3-n via the cable 5. The charger 2 charges the batteries belonging to the IPUs 3-1 to 3-n by supplying power to the IPUs 3-1 to 3-n.

The IPUs 3-1 to 3-n are IPUs manufactured by a manufacturer (the same manufacturer or two or more cooperating manufacturers that are substantially the same) that applies an identical specification to the IPUs, and mounted in different vehicles manufactured by a manufacturer that applies an identical specification.

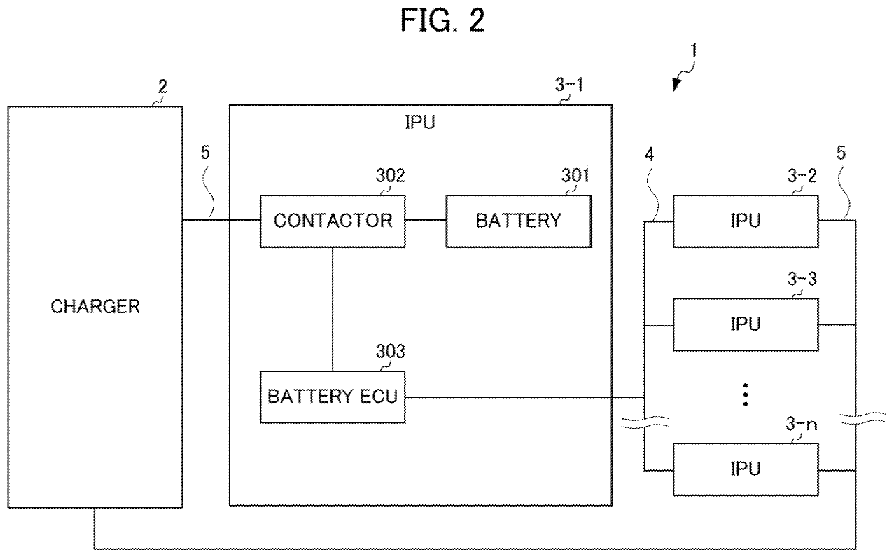

FIG. 2 is a block diagram illustrating a configuration of the IPUs 3-1 to 3-n according to the present embodiment. Since the IPUs 3-1 to 3-n have the same or similar configuration, the configuration of the IPU 3-1 will be described below. As illustrated in FIG. 2, the IPU 3-1 includes a battery 301, a contactor 302, and a battery electric control unit (battery ECU) 303.

The battery 301 is a high-voltage battery that is charged by the charger 2 and supplies electric power to a device by discharging. The battery 301 is, for example, a large-capacity battery in which a plurality of battery cells each including a lithium ion secondary battery are connected in series.

The contactor 302 connects and disconnects power supply from the battery 301 to an electronic device and power supply from the charger 2 to the battery 301, under the control of the battery ECU 303. In the charge control system 1 according to the present embodiment, the contactor 302 connects and disconnects the power supply from the charger 2 to the battery 301.

The battery ECU 303 comprehensively controls the IPU 3-1. The battery ECU 303 includes a processor typified by a CPU, a storage device such as a semiconductor memory, an interface for connection to an external device, and the like.

The CAN bus 4 is a communication line that electrically connects the IPUs 3-1 to 3-n to each other, and allows for mutual communication between the IPUs 3-1 to 3-n. The CAN bus 4 allows for transmission and reception of operation information regarding the contactor 302 between the IPUs 3-1 to 3-n. Specifically, the CAN bus 4 is used for transmitting and receiving bits corresponding to turning ON and OFF the contactor 302, as the operation information.

The IPUs 3-1 to 3-n have the same CAN_ID, which is an identifier for mutual communication via the CAN bus 4 between the IPUs 3-1 to 3-n. Specifically, as described above, since the IPUs 3-1 to 3-n are mounted in different vehicles manufactured by the same manufacturer, the IPUs 3-1 to 3-n have the same CAN_ID.

Thus, in the charge control system 1 according to the present embodiment, based on the operation information provided via the CAN bus 4, the battery ECU 303 causes the contactor 302 of one IPU (e.g., the IPU 3-1) from among the IPUs 3-1 to 3-n to provide power supply to the battery 301 belonging to the one IPU and causes the contactors 302 of the other IPUs (e.g., the IPUs 3-2 to 3-n) to disconnect power supply to the batteries 301 belonging to the other IPUs, thereby performing control such that the charger 2 charges the one IPU without concurrently charging the other IPUs.

Specifically, the battery ECUs 303 of the IPUs 3-1 to 3-n use bits corresponding to turning ON and OFF the contactor 302 in CAN data, as the operation information More specifically, the battery ECUs 303 of the IPUs 3-1 to 3-n set the bit when the contactor 302 is turned ON to “0”, and sets the bit when the contactor 302 is turned OFF to “1”.

For example, when the battery ECU 303 of the IPU 3-1 is to transmit the bit “0” to the other IPUs 3-2 to 3-n via the CAN bus 4, if the battery ECU 303 of the IPU 3-1 receives a bit “1” from any one of the other IPUs 3-2 to 3-n via the CAN bus 4, the battery ECU 303 of the IPU 3-1 determines that the contactor 302 of any one of the other IPUs 3-2 to 3-n is ON, and does not turn on the contactor 302 of the IPU 3-1.

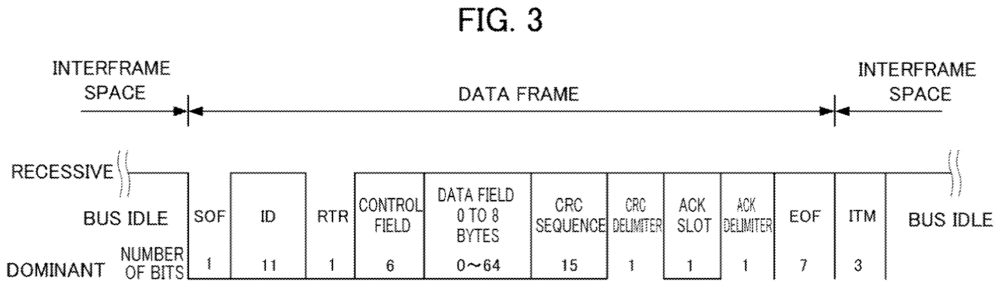

FIG. 3 is a diagram illustrating contents of CAN data that is transmitted via the CAN bus 4. In the example illustrated in FIG. 3, a transmission bit “1” means being recessive, and when all the IPUs transmit the transmission bit “1”, a transmission bit “1” is conveyed to the CAN bus 4. A transmission bit “₀” means being dominant, and when one IPU transmits the transmission bit “0”, a transmission bit “0” is conveyed to the CAN bus 4. In the known example, when all IPUs transmit “1”, a transmission bit “1” is conveyed to a CAN bus. In this case, all the IPUs recognize that none of the IPUs is transmitting a bit “0”.

When one IPU transmits a bit “0” and the other IPUs transmit a bit “1”, a transmission bit “0” is conveyed to the CAN bus. In this case, the one IPU that has transmitted “0” recognizes that its own data is prioritized, whereas each of the other IPUs that have transmitted the bit “1” recognizes the presence of another IPU that has transmitted the bit “0” and is prioritized.

When two IPUs transmit a bit “0” and the other IPUs transmit a bit “1”, a transmission bit “0” is conveyed to the CAN bus. In this case, each of the two IPUs that have transmitted the bit “0” can recognize that its own data is prioritized, but cannot recognize the presence of the other IPU that has transmitted the bit “0”. Each of the other IPUs that have transmitted the bit “1” recognizes the presence of another IPU that has transmitted the bit “0” and is prioritized.

In the known example, when two or more IPUs intend to transmit data at the same time, the above-described recessiveness or dominance of each IPU is determined with reference to the ID included in the CAN data shown in FIG. 3, and when it is recognized that another IPU is to be prioritized, transmission of the CAN data is stopped at that point in time. The prioritized IPU is allowed to transmit the ID to the end and to continue transmitting the subsequent pieces of the CAN data.

The charge control system 1 according to the present embodiment extends the function of determining dominance/recessiveness of IPU not only to the ID but also to the data field of the CAN data illustrated in FIG. 3. In other words, the charge control system 1 retains the bits corresponding to turning ON and OFF the contactor 302 as the operation information in the data field of the CAN data. In this way, the charge control system 1 extends the function of determining dominance/recessiveness to the data field of the CAN data, so that the presence of an IPU in which the contactor 302 is ON can be recognized by the other IPUs.

Since the battery ECUs 303 of the IPUs 3-1 to 3-n meet the same specification, in the information transmitted by the battery ECUs 303, the data, such as the ID information, preceding the operation information is the same for all the IPUs 3-1 to 3-n. As a result, each IPU determines that its own data is conveyed. To give priority to turning ON the contactor 302, the battery ECU 303 sets the bit when the contactor 302 is turned ON to “0”, and sets the bit when the contactor 302 is turned OFF to “1”.

When all the IPUs 3-1 to 3-n transmit a bit “1” (indicating turning OFF the contactor 302), a transmission bit “1” is conveyed to the CAN bus 4. In this case, all the IPUs 3-1 to 3-n can recognize that none of the IPUs is transmitting a bit “0”, and accordingly, recognize that none of the IPUs has the contactor 302 turned ON and is being charged. Thus, all the IPUs 3-1 to 3-n can continue transmitting the subsequent pieces of the CAN data.

When one IPU (e.g., the IPU 3-1) transmits a bit “0” (indicating turning ON the contactor 302) and the other IPUs (e.g., the IPUs 3-2 to 3-n) transmit a bit “1” (indicating turning OFF the contactor 302), a transmission bit “0” is conveyed to the CAN bus 4. In this case, the one IPU transmitting the bit “0” can recognize that its own data is prioritized. Each of the other IPUs transmitting the bit “1” can recognize that another IPU is transmitting the bit “0”, has the contactor 302 tuned ON and is being charged.

Thus, the one IPU transmitting the bit “0” continues transmission of the subsequent pieces of the CAN data, and thereby transmits information necessary for charging, such as voltage information of the battery, to the charger 2. The other IPUs transmitting the bit “1” stop transmission of the subsequent pieces of the CAN data and do not turn on the contactors 302.

When two IPUs (e.g., the IPU 3-1 and the IPU 3-2) transmit a bit “0” (indicating turning ON the contactor 302) and the other IPUs (e.g., the IPUs 3-3 to 3-n) transmit a bit “1” (indicating turning OFF the contactor 302), a transmission bit “0” is conveyed to the CAN bus 4. However, by the control in the above-described case where one IPU (e.g., the IPU 3-1) transmits the bit “0” (indicating turning ON the contactor 302) and the other IPUs (e.g., the IPUs 3-2 to 3-n) transmit the bit “1”, a situation in which two or more IPUs transmit the bit “0” at the same time is not allowed to take place.

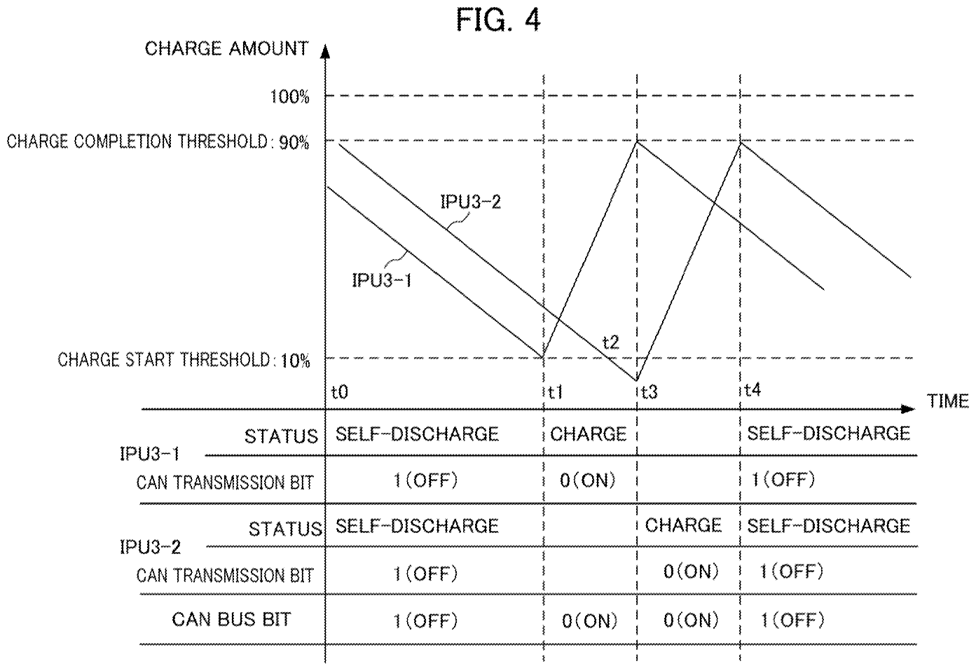

FIG. 4 illustrates, in time series, an example of charging operations by the two IPUs 3-1 and 3-2 according to the present embodiment. It should be noted that the rate of change in the charge amount is schematically shown in FIG. 4 and is different from the actual rate of change in the charge amount. Furthermore, the charge start threshold and the charge completion threshold are different from the thresholds that are actually used.

The IPU 3-1 starts self-discharge from time t0, and transmits a bit “1” (indicating turning OFF the contactor 302). The IPU 3-1 then reaches the charge start threshold (10% of full charge) at time t1, and in response to this, transmits a bit “0” (indicating turning ON the contactor 302) and starts charging. Thereafter, the IPU 3-1 reaches the charge completion threshold (90% of full charge) at time t3, and in response to this, transmits a bit “1” (indicating turning OFF the contactor 302) and starts self-discharge.

The IPU 3-2 starts self-discharge from time t0, and transmits a bit “1” (indicating turning OFF the contactor 302). The IPU 3-2 then reaches the charge start threshold (10% of full charge) at time t2, but continues self-discharge on standby without starting charge because the IPU 3-2 has received the bit “0” (indicating turning ON the contactor 302) transmitted by the IPU 3-1.

Thereafter, when the IPU 3-1 transmits the bit “1” (indicating turning OFF the contactor 302) at time t3, and the bit conveyed via the CAN bus 4 switches to “1”, the IPU 3-2 transmits a bit “0” (indicating turning ON the contactor 302) and starts charging. At time t3, the bit transmitted via the CAN bus 4 is momentarily “1” (indicating turning OFF the contactor 302) and instantaneously switches to “0” (indicating turning ON the contactor 302). Thereafter, the IPU 3-2 reaches the charge completion threshold (90% of full charge) at time t4, and in response to this, transmits a bit “1” (indicating turning OFF the contactor 302) and starts self-discharge.

By performing the above-described control, the charge control system 1 according to the present embodiment uses the same CAN_ID to automatically turn ON only the contactor 302 of one of the IPUs 3-1 to 3-n and automatically turn OFF the contactors 302 of the other IPUs. Thus, the charge control system 1 can perform control such that only the battery 301 of one of the IPUs 3-1 to 3-n is charged without concurrently charging the batteries 301 of the other IPUs.

The present embodiment exerts the following effects. The charge control system 1 includes: the charger 2, the plurality of IPUs 3-1 to 3-n that are electrically connected to the charger 2, and the CAN bus 4 that allows for mutual communication between the IPUs 3-1 to 3-n. Each of the plurality of IPUs 3-1 to 3-n includes the battery 301, the contactor 302 that disconnects power supply from the charger 2 to the battery 301, and the battery ECU 303 that controls the IPUs 3-1 to 3-n. The CAN bus 4 allows for transmission and reception of the operation information regarding each contactor 302 between the IPUs 3-1 to 3-n. Based on the operation information provided via the CAN bus 4, the battery ECU 303 causes the contactor 302 of one IPU (e.g., the IPU 3-1) from among the plurality of IPUs 3-1 to 3-n to provide power supply to the battery 301 belonging to the one IPU and causes the contactors 302 of the other IPUs (e.g., the IPUs 3-2 to 3-n) to disconnect power supply to the batteries 301 belonging to the other IPUs, thereby performing control such that the charger 2 charges the one IPU without concurrently charging the other IPU.

The charge control system 1 performs the above-described control to make it possible to charge only the battery 301 of one of the IPUs 3-1 to 3-n, without concurrently charging the batteries 301 of the other IPUs. Thus, the charge control system 1 is capable of charging only the battery 301 of one IPU while eliminating the need for introducing a new mechanism into the charger 2, thereby making it possible to reduce the cost for reusing the IPUs 3-1 to 3-n.

In addition, the IPUs 3-1 to 3-n have the same CAN_ID, which is an identifier for mutual communication between the IPUs 3-1 to 3-n via the CAN bus 4. By virtue of this configuration, the charge control system 1 can automatically turn ON only the contactor 302 of one of the IPUs 3-1 to 3-n by using the same CAN_ID common to the IPUs 3-1 to 3-n.

It should be noted that the present invention is not limited to the embodiment described above. The specifics of the embodiment may be appropriately changed without deviating from the spirit of the present invention.

### EXPLANATION OF REFERENCE NUMERALS

1: Charge control system
2: Charger
3-1 to 3-n: IPU (battery module)
4: CAN bus (communication line)
5: Cable
301: Battery
302: Contactor (Disconnector)
303: Battery ECU

What is claimed is:

1. A charge control system comprising:
a charger;
a plurality of battery modules that are electrically connected to the charger; and
a communication line that allows for mutual communication between the plurality of battery modules,
each of the plurality of battery modules including
a battery,
a disconnector configured to disconnect power supply from the charger to the battery, and
a battery controller configured to control the battery modules, wherein
the communication line allows for transmission and reception of operation information regarding the disconnector between the battery modules, and
based on the operation information provided via the communication line, the battery controller causes the disconnector of one battery module from among the plurality of battery modules to provide power supply to the battery belonging to the one battery module and causes the disconnector of a rest of the plurality of battery modules to disconnect power supply to the battery belonging to the rest of the plurality of battery modules, thereby performing control such that the charger charges the battery belonging to the one battery module without concurrently charging the battery belonging to the rest of the plurality of battery modules.

2. The charge control system according to claim 1, wherein the battery modules have an identical identifier for mutual communication between the battery modules via the communication line.
